(19) United States
(12) Patent Application Publication
(10) Pub. No.: US 2022/0034139 A1
(43) Pub. Date: Feb. 3, 2022

(54) MOTOR VEHICLE HAVING A LEAF ELEMENT AND AN ADJUSTING DEVICE FOR MOVING THE LEAF ELEMENT, AND ADJUSTING DEVICE FOR MOVING A LEAF ELEMENT OF A MOTOR VEHICLE

(71) Applicants: Audi AG, Ingolstadt (DE); Stabilus GmbH, Koblenz (DE)

(72) Inventors: Steffen ULLRICH, Garching (DE); Alexander KNEIP, Macken (DE); Rüdiger SCHÖMEHL, Koblenz (DE); Sascha BLATH, Eitelborn (DE); Jörg WOLF, Urmitz (DE)

(73) Assignees: AUDI AG, Ingolstadt (DE); Stabilus GmbH, Koblenz (DE)

(21) Appl. No.: 17/274,994

(22) PCT Filed: Sep. 10, 2019
(86) PCT No.: PCT/EP2019/074027

§ 371 Date: Mar. 10, 2021

(30) Foreign Application Priority Data
Sep. 13, 2018 (DE) 10 2018 215 619.0

(51) Int. Cl. E05F 1/10; E05F 15/622; E05F 3/10; E05F 3/12

(52) U.S. Cl. CPC E05F 1/1091; E05F 15/622; E05Y 2900/548; E05F 3/12; E05Y 2800/242; E05F 3/10

(57) ABSTRACT

The present disclosure relates to a motor vehicle, comprising a leaf element, which is movably held at a bearing point of the motor vehicle, and an adjusting device by means of which the leaf element can be moved between a closed position, in which the leaf element closes an opening of the motor vehicle, and an open position, wherein the adjusting device comprises a spring component which, on the one hand, is coupled at least indirectly to the leaf element and, on the other hand, at least indirectly to a holding region of the motor vehicle, and which comprises a sleeve element and a piston element which is inserted into a sleeve interior of the sleeve element in certain regions and is displaceable relative to the sleeve element during the movement of the leaf element between the closed position and the open position. The spring component is designed as a spring strut and comprises a damping device for damping during the displacement of the piston element relative to the sleeve element during the movement of the leaf element between the open position and the closed position. A further aspect of the present disclosure relates to an adjusting device.

### TECHNICAL FIELD

The present disclosure relates to a motor vehicle which includes at least one leaf element, which is movably held at at least one bearing point of the motor vehicle, and at least one adjusting device for moving the leaf element. A second aspect of the present disclosure relates to an adjusting device for moving at least one leaf element of a motor vehicle.

### BACKGROUND

In modern motor vehicles, leaf elements, in particular leaf elements that open against gravity, such as, for example, tailgates, are often opened and/or closed by an electric motor. This allows a comfortable and safe opening and closing of the leaf element for persons with disabilities, for example wheelchair users, or persons who, for example, do not have a hand free to manually operate the leaf element after shopping, Gas springs, for example, are often used when moving tailgates, as can be seen, for example, from the publications DE 10 2006 016 826 Al or DE 10 2006 055 192 113. In the case of motor-driven leaf elements of a motor vehicle known from the prior art, an electromotive force is often applied to a first side of the leaf element and such a gas spring engages on a second side of the leaf element opposite the first side in the transverse direction of the vehicle. If an event of damage occurs in which, for example, a. coupling between the leaf element and a drive motor can break or tear or, for example, an anchoring of the drive motor can tear, there is a risk that the leaf element will fall from an open position into a closed position at high speed under the influence of gravity. This can lead to serious injuries to persons in the vicinity of the leaf element.

### BRIEF DESCRIPTION OF THE DRAWINGS/FIGURES

FIG. 1 is a plan view in the vehicle longitudinal direction of a rear of a motor vehicle, which has a leaf element designed as a tailgate and has a leaf element which is moved into an open position by means of an adjusting device of the motor vehicle.

FIG. 2 is a sectional view through a spring component of the adjusting device; and

FIG. 3 is an enlarged representation of a region A framed in dashed lines in FIG. 2, which shows a damping device of the spring component.

### DETAILED DESCRIPTION

The object of the present disclosure is to create a motor vehicle and an adjusting device of the type mentioned above, by means of which an uncontrolled movement of the leaf element between an open position and a closed position of the leaf element can be prevented in the event of damage.

This object is achieved by a motor vehicle and by an adjusting device, as exemplified by the independent claims. Advantageous developments of the present disclosure are the subject matter of the dependent claims.

In some aspects of the present disclosure relates to a motor vehicle, comprising at least one leaf element, which is movably held at at least one bearing point of the motor vehicle, and at least one adjusting device by means of which the at least one leaf element can be moved between a closed position, in which the leaf element closes an opening of the motor vehicle, and at least one open position, wherein the at least one adjusting device includes at least one spring component which, on the one hand, is coupled at least indirectly to the at least one leaf element and, on the other hand, at least indirectly to a holding region of the motor vehicle, and which includes at least one sleeve element and at least one piston element which is inserted into a sleeve interior of the sleeve element at least in certain regions and is displaceable relative to the at least one sleeve element during the movement of the at least one leaf element between the closed position and the at least one open position. By way of a non-limiting example, the leaf element can be designed as a tailgate, as an engine hood, or as a vehicle door.

A movement from the closed position to the open position can take place against gravity. In other words, the leaf element can be moved against gravity from the closed position into the at least one open position. The sleeve element can have an inner jacket surface, which can also be designated the inner surface, on which the sleeve element can be guided in a displaceable manner. In some aspects, the inner surface of the sleeve element is of cylindrical design because of the low expenditure in the manufacture of the sleeve element. In principle, however, another shape of the inner surface would also be conceivable, for example a cuboid configuration of the inner surface. The piston element can be displaceable relative to the sleeve element, in particular depending on the movement of the leaf element between its at least one open position and its closed position.

The piston element can be connected at least indirectly to the bearing point of the motor vehicle. The sleeve element can be connected at least indirectly to the leaf element. Alternatively, the sleeve element can also be connected at least indirectly to the bearing point of the motor vehicle and the piston element can be connected at least indirectly to the leaf element.

According to the present disclosure, the at least one spring component is designed as a spring strut and includes at least one damping device for damping during the displacement of the at least one piston element relative to the at least one sleeve element during the movement of the leaf element between the at least one open position and the closed position. This is advantageous because the spring strut can counteract a. displacement of the leaf element during the movement thereof between the at least one open position and the closed position by applying a spring force to the leaf element and thereby can prevent, for example, the leaf element from falling uncontrollably in the direction of the closed position. In addition, by applying a damping force to the leaf element, the damping device can counteract the movement of the leaf element during the movement thereof between the at least one open position and the closed position and thereby also contribute to preventing, for example, the uncontrolled movement of the leaf element in the direction of the closed position or in the direction of the open position. Both through the design of the spring component as a spring strut and through the provided damping device, the leaf element can be effectively decelerated and thus braked when it is moved between the at least one open position and the closed position.

The piston element and the damping device in some aspects can be designed in one piece. In other words, the piston element and the damping device can be connected to one another in one piece. As a result, installation, in particular simultaneous installation, of the piston element and the damping device can be carried out with particularly little effort. Alternatively, the sleeve element and the damping device can advantageously be designed in one piece. In other words, the sleeve element and the damping device can be connected to one another in one piece. As a result, installation, in particular simultaneous installation, of the sleeve element and the damping device can be carried out with particularly little effort.

The present disclosure is based on the knowledge that conventional gas springs known from the prior art in the above-mentioned events of damage in which a weight force of the leaf element, for example due to an anchoring of a drive motor tearing out when the leaf element is open, can act suddenly on the gas springs, can only insufficiently contribute to the deceleration of the leaf element during the movement thereof. In addition, tension springs are sometimes used in gas springs known from the prior art, which can even accelerate the leaf element during the movement thereof. In contrast, by designing the spring component as a spring strut and by providing the damping device, an effective deceleration, i.e. braking of the leaf element during the movement thereof between the open position and the closed position, for example in the direction of the closed position, can be brought about. In other words, the braking can act in all directions of adjustment of the leaf element.

Another advantage of the spring strut and the damping device is that these possible pivoting movements of the leaf element can counteract in different, in particular opposite, adjustment directions during the installation of various components of the leaf element. This is advantageous because, even when the weight of the leaf element changes during the installation of the components of the leaf element, an effective deceleration can be achieved by the spring strut and the damping device in the different adjustment directions. If, for example, the leaf element is still light in weight at an early stage of installation, since sonic components, such as a pane (in the case of a leaf element designed as a tailgate, for example) have not yet been installed, the spring strut and damping device can, for example, prevent a sudden movement (for example snap open movement) of the leaf element so that there is no injury to the person performing the installation. Furthermore, for example, spindle drives for moving the leaf element can be protected from damage at this early stage of installation. Such spindle drives are designed for the movement of the leaf element after the installation of the components has been completed. In the event of a sudden movement, there would be a risk of damage to such a spindle drive, which can be avoided by the spring strut and damping device.

In some aspects of the present disclosure, by means of the damping device, during the displacement of the piston element relative to the sleeve element, a medium contained. in the sleeve interior is interchangeable at least in certain regions between at least two interior subregions of the sleeve interior delimited from one another by a piston element region of the at least one piston element. This is advantageous since the medium can thus be moved in the sleeve interior, i.e. within the sleeve element, so that a damping effect can take place by interchanging the medium between the interior subregions. The damping effect can then be achieved by displacing the medium from one of the interior subregions into the other interior subregions. By interchanging the medium between the interior subregions, the medium can be prevented from escaping to the environment of the sleeve element. Correspondingly, environmental influences, for example the entry of contaminants from the environment into the sleeve interior, can also be excluded.

In principle, however, it is also conceivable to configure the damping device in such a way that the medium is interchangeable between the sleeve interior and the environment of the sleeve element, whereby a damping effect can be achieved with particularly little effort. For example, it is possible to design the damping device as a simple configured passage opening through a sleeve element wall of the sleeve element, via which the medium can be interchanged between the sleeve interior and the environment.

In some aspects of the present disclosure, the damping device includes at least one bypass which extends in the axial extension direction of the spring component at least over a subregion of the sleeve element and via which the medium is interchangeable between the at least two interior subregions. This is advantageous because the bypass is particularly easy to produce, so that the medium interchange between the interior subregions can be implemented with particularly little effort. During the displacement of the piston element in the axial extension direction of the spring component relative to the sleeve element, the bypass can serve for the medium and allow a flow of the medium within the bypass and relative to the piston element. If the piston element covers the bypass in a transverse extension direction of the spring component perpendicular to the axial extension direction, the medium can be throttled through the bypass and interchanged between the interior subregions, whereby a damping effect can be achieved. By way of a non-limiting example, the bypass can be designed-as a groove or as a channel.

Preferably, at least two bypass subregions of the bypass can each have subregion cross sections which are different from one another and are oriented perpendicular to the axial extension direction. As a result, a change in the damping effect can be achieved in a particularly inexpensive manner. As a result of the different subregion cross sections, a flow speed of the medium when flowing through the bypass subregions and, depending on this, also a displacement speed of the piston element during the displacement thereof relative to the sleeve element can be varied. In particular, the at least two bypass subregions of the bypass can bring about a particularly simple end position damping during the displacement of the piston element in the direction of at least one sleeve element end of the sleeve element.

In some aspects of the present disclosure, the damping device includes at least one overflow opening which extends in the axial extension direction of the at least one spring component at least through the piston element region and via which the medium is interchangeable between the at least two interior subregions. This is advantageous because the medium is hereby interchangeable between the interior subregions by means of the overflow opening over an entire travel path of the piston element along the sleeve element. This allows a permanent interchanging, i.e. a permanent overflow of the medium when moving the piston element between the interior subregions, independently of the respective positions of the piston element relative to the sleeve element, whereby a permanent damping effect can advantageously be achieved.

The damping device can include a valve having a valve body which can be moved between a valve open position in which the valve body releases the overflow opening for interchanging the medium and a valve closed position in which the valve body blocks the overflow opening for interchanging the medium. The valve can include a valve spring in order to move the valve body between the valve open position and the valve closed position. The valve body can be designed as a ball, for example. The valve can for example be designed as a check valve, whereby a damping dependent on a direction of movement of the piston element relative to the sleeve element can be achieved. For example, when the leaf element is moved from the open position into the closed position, strong damping can be achieved if the valve body is held in the valve closed position.

In some aspects of the present disclosure, the overflow opening is narrowed at least in certain regions. This is advantageous because the narrowing allows, for example, simple valve retrofitting, the narrowing being able to form a valve seat. In addition, the overflow opening, which is narrowed in certain regions, can form a nozzle.

In some aspects of the present disclosure, the at least one spring component includes at least one compression spring, by means of which a spring force can be exerted at least indirectly on the at least one leaf element in order to support the movement of the at least one leaf element by the spring force between the closed position and the at least one open position. This is advantageous because the compression spring contributes in a particularly favorable way to braking the leaf element during the movement thereof. The compression spring can exert the spring force as a compressive force.

The movement of the at least one leaf element from the closed position into the at least one open position can be supported by means of the compression spring, whereby the leaf element can be opened with particularly little effort.

In contrast to systems known from the prior art, in which tension springs are often used, which cause an accelerated closing of the leaf elements, the compression spring allows an effective deceleration of the movement between the open position and the closed position. In other words, a movement speed of the leaf element during the movement from the at least one open position into the closed position can be reduced particularly effectively by the compression spring.

The at least one compression spring can be pre-tensioned in all positions of the piston element relative to the sleeve element and exert the spring force at least indirectly, on the one hand, on the holding region and, on the other hand, on the leaf element. As a result, the spring component can permanently counteract the displacement or movement of the leaf element from the at least one open position into the closed position, whereby a dangerous closing of the leaf element can be prevented particularly effectively.

In some aspects of the present disclosure, the adjusting device has at least one additional spring component which, on the one hand, is coupled at least indirectly to the at least one leaf element and, on the other hand, at least indirectly to an additional holding region of the motor vehicle and by means of which an additional spring force supporting the movement of the at least one leaf element between the closed position and the at least one open position can be exerted on the at least one leaf element. This is advantageous because the additional spring component provides increased design freedom in order to achieve a symmetrical application of force to the leaf element during the movement thereof between the open position and the closed position. For this purpose, the spring component and the additional spring component can be coupled to the leaf element on opposite sides thereof. The additional spring component can be designed, for example, as a gas spring or as a further spring strut.

In some aspects of the present disclosure, the adjusting device includes at least one actuator by means of which an actuator force can be exerted at least indirectly on the at least one leaf element in order to move the at least one leaf element between the closed position and the at least one open position. This is advantageous because the actuator allows the movement of the leaf element with particularly little effort without manual intervention between the closed position and the at least one open position, The application of the actuator force is particularly helpful when the movement from the closed position into the open position or vice versa takes place against the force of gravity, as is often the case, for example, with leaf elements designed as tailgates.

In the case of motor vehicles designed as pick-ups, for example, a leaf element designed as a tailgate can be moved from the closed position into the at least one open position in the direction of gravity. In this case too, not only can the spring strut and the damping device effect an effective deceleration in the movement, but the movement can also be supported by the actuator.

in some aspects of the present disclosure, the adjusting device includes at least one spindle which is coupled, on the one hand, to the actuator and, on the other hand, to the leaf element. This is advantageous because the spindle can, for example, convert a rotary movement of a drive shaft of the actuator into a translational movement in a particularly simple manner. The additional spring component can be coupled to the spindle and can be telescoped, for example, by driving the spindle by means of the actuator, to name just one example.

Another aspect of the present disclosure relates to an adjusting device for moving at least one leaf element of a motor vehicle, by means of which the at least one leaf element can be moved between a closed position, in which the leaf element closes an opening of the motor vehicle, and at least one open position, wherein the at least one adjusting device includes at least one spring component which, on the one hand, is designed to couple at least indirectly to the at least one leaf element and, on the other hand, is designed to couple at least indirectly to a holding region of the motor vehicle, and which includes at least one sleeve element and at least one piston element which is inserted into a sleeve interior of the sleeve element at least in certain regions and is displaceable relative to the at least one sleeve element during the movement of the at least one leaf element between the closed position and the at least one open position. According to the present disclosure, the at least one spring component is designed as a spring strut and includes at least one damping device for damping during the displacement of the at least one piston element relative to the at least one sleeve element during the movement of the leaf element between the at least one open position and the closed position. This adjusting device can prevent uncontrolled movement of the leaf element between an open position and a closed position of the leaf element in the event of damage.

The present disclosure also includes developments of the adjusting device according to the present disclosure which have features such as those previously described in connection with the developments of the motor vehicle according present disclosure. For this reason, the corresponding developments of the method according to the present disclosure are not described again herein.

Embodiments of the invention are described below.

The embodiments explained in the following are preferred embodiments. In the embodiments, the described components of the embodiments each represent individual features, which are to be considered to be independent of one another. Furthermore, the described embodiments may also be supplemented by further features as already described.

In the drawings, the same reference signs refer to functionally identical elements,

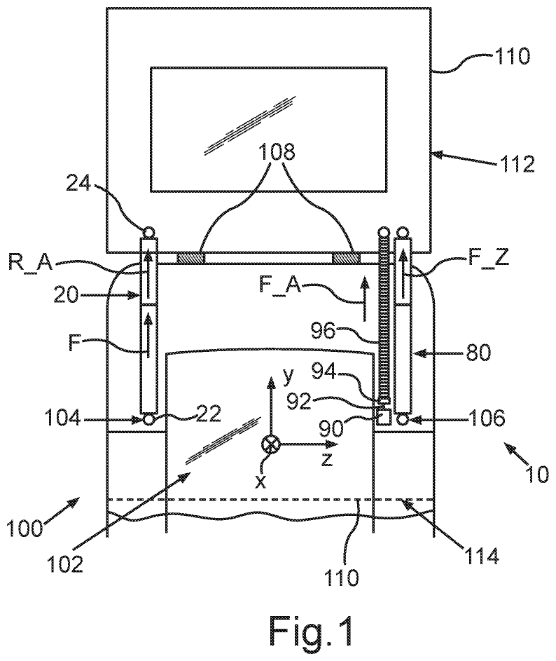

FIG. 1 shows a plan view of a rear of a motor vehicle 100 in the vehicle longitudinal direction, which corresponds to a longitudinal extension direction x of a coordinate system shown in FIG. 1 and related to the motor vehicle 100. The coordinate system is spanned by the longitudinal extension direction x, by a transverse extension direction z, and by a vertical extension direction y. The transverse extension direction z corresponds to a transverse direction of the motor vehicle 100 and the vertical extension direction y corresponds to a vertical direction of the motor vehicle 100.

The motor vehicle 100 includes a leaf element 110 movably held at two bearing points 108 of the motor vehicle 100. In the present case, the leaf element 110 is designed as a tailgate, which can be moved in the vertical extension direction y between a closed position 114, indicated in dashed lines in FIG. 1, and an open position 112. In the present case, the bearing points 108 are designed as respective hinges. Accordingly, the leaf element 110 can be pivoted in the vertical extension direction y between the open position 112 and the closed position 114.

The motor vehicle 100 also includes an adjusting device 10, by means of which the at least one leaf element 110 can be moved between a closed position 114, in which the leaf element 110 closes an opening 102 of the motor vehicle 100, and at least one open position 112, i.e., can be pivoted about the bearing points 108. In the present case, the opening 102 corresponds to a trunk opening via which a vehicle interior, namely in the present case a trunk of the motor vehicle 100 in the open position 112 of the leaf element 110 (tailgate) is accessible from the direction of an environment of the motor vehicle 100.

The adjusting device 10 includes a spring component 20 which is coupled at least indirectly to the leaf element 110 on the one hand and at least indirectly to a holding region 104 of the motor vehicle 100 on the other hand. The holding region 104 can be designed, for example, as a fastening flange to which a first connection element 22 of the spring component 20 can be connected to the holding region 104. The spring component 20 is coupled to the leaf element 110 via a second connection element 24 of the spring component 20 opposite the first connection element 22 in the axial extension direction R_A of the spring component 20. The connection elements 22, 24 can, for example, be designed as respective ball sockets.

By means of the spring component 20, a spring force F, illustrated in FIG. 1 by an arrow, can be exerted on the leaf element 110 on the one hand and on the holding region 104 on the other hand. The spring force F can support the movement of the leaf element 110, for example, from the closed position 114 into the open position 112, i.e., act in the direction of the arrow in the vertical extension direction y.

The adjusting device 10 also includes an additional spring component 80, which can be designed as a gas spring, for example. The additional spring component 80 is in the present case coupled at least indirectly to the leaf element 110 on the one hand and to an additional holding region 106 of the motor vehicle 100 on the other hand. The additional holding region 106, like the holding region 104, can be designed as a fastening flange.

By means of the additional spring component 80, an additional spring force F_Z which supports the movement of the leaf element 110 from the closed position 114 into the open position 112 can be excited on the leaf element 110.

The adjusting device 10 further includes an actuator 90, which in some aspects is designed as an electric motor. The actuator 90 is fixated on the motor vehicle 100, for example on the additional holding region 106. The actuator 90 includes a drivable drive shaft 92 which has a connecting element 94 at one shaft end. The connecting element 94 is coupled to a spindle 96, so that the spindle 96 can be driven as a whole via the drive shaft 92 of the actuator 90. The spindle 96 can be coupled on the one hand to the connecting element 94 and on the other hand indirectly or directly to the leaf element 110. In addition, the spindle 96 can be oriented, for example, parallel to the spring component 20, as is shown in FIG. 1. A bidirectional pivoting of the leaf element 110 can be effected by means of the actuator 90, so that the leaf element 110 can accordingly be moved (pivoted) from the closed position 114 into the open position 112 and vice versa. by means of the actuator 90.

By means of the actuator 90, an actuator force illustrated by an arrow in FIG. 1, can be exerted by means of the spindle 96 on the leaf element 110 in order to move the leaf element 110 between the closed position 114 and the at least one open position 112.

The leaf element 110 can be moved or pivoted from the closed position 114 into the open position 112 against gravity and thus in the present case in the direction of the arrow of the vertical extension direction y by applying force with the actuator force A, with the spring force F, and the additional spring force F_Z. By reversing an effective direction of the actuator force A, the leaf element 110 can be moved (pivoted) from the open position 112 into the closed position 114.

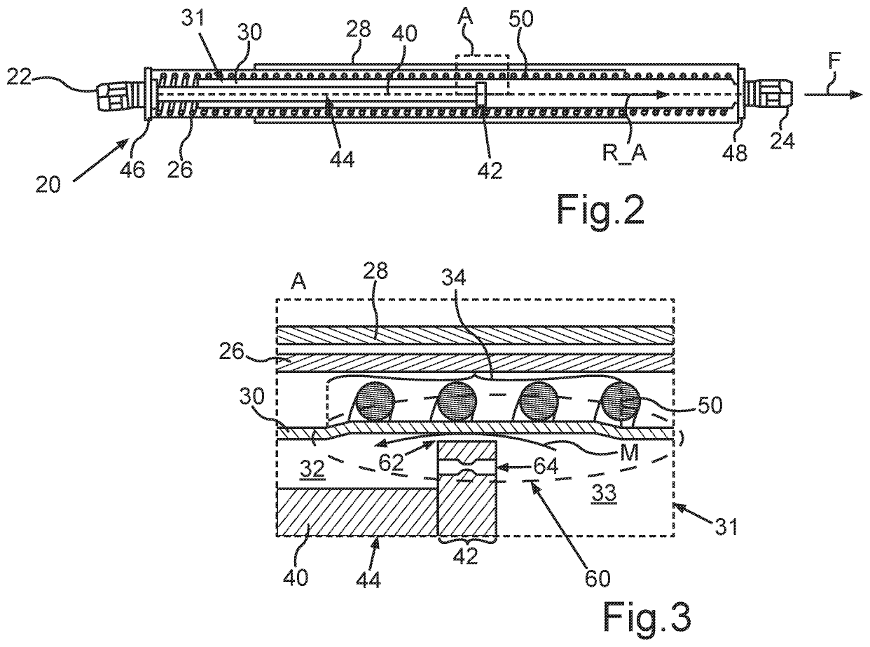

The spring component 20 shown in section and enlarged in FIG. 2 includes a sleeve element 30 and a piston element 40, which is inserted into a sleeve interior 31 of the sleeve element 30 in certain regions. During the movement of the leaf element 110 between the closed position 114 and the open position 112, the piston element 40 is displaceable relative to the at least one sleeve element 30 in or against the direction of the arrow of the axial extension direction R

In order to avoid uncontrolled dropping of the leaf element 110 from the open position 112 (against the vertical extension direction y) into the closed position 114 in the event of damage, in which, for example, the connecting element 94 breaks and thus the application of force by means of the actuator force F_A can suddenly be omitted, the spring component 20 is designed as a spring strut and includes a damping device 60. In the present case, the damping device 60 is surrounded by an ellipse in dashed lines, which is intended to delimit the components assigned to the damping device 60.

The damping device 60 serves for damping during the displacement of the piston element 40 relative to the sleeve element 30 during the movement of the leaf element 110 between the open position 112 and the closed position 114.

By means of the damping device 60, during the displacement of the piston element 40 relative to the sleeve element 30, a medium M contained in the sleeve interior 31 is interchangeable in certain regions between two interior subregions 32, 33 of the sleeve interior 31 delimited from one another by a piston element region 42 of the piston element 40. The medium M is indicated in FIG. 3 by an arrow. The medium M can be a gas, Alternatively, the medium can be a liquid. in the present case, the piston element region 42 is designed as the piston end of the piston element 40. The piston element region 42 has a larger diameter, extending perpendicular to the axial extension direction R_A, than a piston rod region 44. The piston element region 42 and the piston rod region 44 of the piston element 40 are in the present case connected to one another in one piece.

The damping device 60 includes a bypass 62, which in the present case is designed as a groove, which extends in the axial extension direction R_A of the spring component 20 over a subregion 34 of the sleeve element 30 and via which the medium M is interchangeable between the at least two interior subregions 32, 33.

In addition, the damping device 60 includes an overflow opening 64 which extends in the axial extension direction R_A of the spring component 20 at least through the piston element region 42 and via which the medium M is interchangeable between the two interior subregions 32, 33. In order to clear the overflow opening 64 as required for interchanging the medium M, the damping device 60 can include a valve (not shown here), which can be designed as a check valve, for example. In the present case, the overflow opening 64 is narrowed in certain regions.

The spring component 20 includes a compression spring 50, by means of which the spring force F can be indirectly exerted as a compressive force on the leaf element 110 in order to support the movement of the leaf element 110 from the closed position 114 into the open position 112 by the spring force F. The compression spring 50 is designed in the present case as a helical spring. Both the sleeve element 30 and the piston element 40 are surrounded on the circumferential side by the compression spring 50. In other words, both the sleeve element 30 and the piston element 40 are inserted into the compression spring 50.

The piston rod region 44 is coupled to the first connection element 22 via a first disk element 46 of the spring component 20. The sleeve element 30 is fastened to a second disk element 48 of the spring component 20 opposite the first disk element 46 in the axial extension direction R_A. The sleeve element 30 is coupled to the second connection element 24 via the second disk element 48. The first disk element 46 and the second disk element 48 are in the present case designed as respective support disks, between which the compression spring 50 is braced.

The spring component 20 further includes a first protective sleeve 26 and a second protective sleeve 28. The two protective sleeves 26, 28 are arranged one inside the other and thereby form a telescopic protective sleeve arrangement that surrounds the compression spring 50, the sleeve element 30, and the piston element 40 in the circumferential direction. In the present case, the first protective sleeve 26 is inserted into the second protective sleeve 28. The first protective sleeve 26 is connected to the first disk element 46, whereas the second protective sleeve 28 is connected to the second disk element 48.

In the case of the present motor vehicle 100 or by the present adjusting device 10, in the event of damage, for example, if the actuator 90 fails or if the connection between the additional spring component 80 and the leaf element 110 is detached, a controlled lowering, in other words, controlled pivoting of the leaf element 110, which is designed as a tailgate in the present case, from the open position 112 into the closed position 114 can be ensured.

The spring component 20 designed as a spring strut or the damping device 60 can cause a controlled retraction of the piston element 40 in the direction of the arrow of the axial extension direction R into the sleeve element 30 and the leaf element 110 can thereby be braked during its pivoting movement from the open position 112 into the closed position 114, whereby largely avoiding serious injuries to persons standing in the pivoting range of the leaf element 110.

The damping device 60 provides insertion damping when the leaf element 110 is pivoted. The actuator 90 is coupled at least indirectly to a so-called active side of the leaf element 110. On an opposite, so-called passive side of the leaf element 110, the spring component 20 is coupled to the leaf element 110. If an event of damage occurs, a controlled lowering of the leaf element 110 against the arrow direction of the vertical extension direction y can take place with the aid of the damping device 60 or the spring component 20 designed as a spring strut. The groove 62 (bypass) can, as can be seen in FIG. 3, extend in or along the sleeve element 30, wherein the sleeve element 30 can also be designated as a pressure pipe. The overflow opening 64 can be designed as a nozzle in the piston element 40 or in the piston element region 42 in order to provide the desired. insertion damping. A particularly advantageous damping effect can be achieved if both the groove 62 and the overflow opening 64 are provided.

Furthermore, it can be advantageous to provide a plurality of bypasses 62, such as grooves 62, such that a damping effect that is particularly needs-based and dependent on a travel path of the piston element 40 can be achieved. The damping device 60 can also provide an extension damping so that a so-called “snap open” movement of the leaf element 110, in other words a particularly rapid pivoting movement of the leaf element 110 from the closed position 114 into the open position 112, can be avoided. By avoiding this “snap open” movement, injuries or damage to the actuator 90 can also be prevented.

1.-10. (canceled)

11. A motor vehicle comprising:
at least one leaf element, which is movably held at at least one bearing point of the motor vehicle; and
at least one adjusting device to move the at least one leaf element between a closed position and at least one open position, wherein the at least one leaf element closes an opening of the motor vehicle when the at least one leaf element is in the closed position,
wherein the at least one adjusting device comprises at least one spring component, the at least one spring component being coupled at least indirectly to the at least one leaf element and indirectly to a holding region of the motor vehicle,
wherein the at least one spring component comprises at least one sleeve element, and at least one piston element, the at least one piston element being inserted into a sleeve interior of the sleeve element at least in certain regions and being displaceable relative to the at least one sleeve element during the movement of the at least one leaf element between the closed position and the at least one open position, and
wherein the at least one spring component is configured as a spring strut, the at least one spring component further comprising at least one damping device for damping during the displacement of the at least one piston element relative to the at least one sleeve element during the movement of the at least one leaf element between the at least one open position and the closed position.

12. The motor vehicle of claim 11, wherein the damping device comprises a medium in the sleeve interior that is interchangeable at least in certain regions between at least two interior subregions of the sleeve interior during the displacement of the piston element relative to the sleeve element, and wherein the interior subregions are delimited from one another by a piston element region of the at least one piston element.

13. The motor vehicle of claim 12, wherein the damping device further comprises at least one bypass that extends in the axial extension direction of the spring component at least over a subregion of the sleeve element, and wherein the medium is interchangeable between the at least two interior subregions.

14. The motor vehicle of claim 12. wherein the damping device further comprises at least one overflow opening that extends in the axial extension direction of the at least one spring component at least through the piston element region, and wherein the medium is interchangeable between the at least two interior subregions.

15. The motor vehicle of claim 14, wherein the at least one overflow opening is narrowed in certain regions.

16. The motor vehicle of claim 11, wherein the at least one spring component further comprises at least one compression spring, the at least one compression spring configured to exert a spring force at least indirectly on the at least one leaf element in order to support the movement of the at least one leaf element by the spring force between the closed position and the at least one open position.

17. The motor vehicle of claim 11, wherein the adjusting device further comprises at least one additional spring component, the at least one additional spring component being coupled to the at least one leaf element and to an additional holding region of the motor vehicle, and wherein the at least one additional spring component is configured to produce an additional spring force to be exerted on the at least one leaf element to support the movement of the at least one leaf element between the closed position and the at least one open position.

18. The motor vehicle of claim 11, wherein the at least one adjusting device further comprises at least one actuator configured to produce an actuator force for exertion at least indirectly on the at least one leaf element in order to move the at least one leaf element between the closed position and the at least one open position.

19. The motor vehicle of claim 18, wherein the at least one adjusting device further comprises at least one spindle that is coupled to the actuator and to the leaf element.

20. An adjusting device for moving at least one leaf element of a motor vehicle between a closed position and at least one open position, the at least one leaf element closing an opening of the motor vehicle when the at least one leaf element is in the closed position, the adjusting device comprising:
at least one spring component coupled at least indirectly to the at least one leaf element and at least indirectly to a holding region of the motor vehicle, the at least one spring component comprising:
at least one sleeve element, and
at least one piston element that is inserted into a sleeve interior of the sleeve element at least in certain regions, and is displaceable relative to the at least one sleeve element during the movement of the at least one leaf element between the closed position and the at least one open position,
wherein the at least one spring component is configured as a spring strut, the at least one spring component further comprising at least one damping device for damping during the displacement of the at least one piston element relative to the at least one sleeve element during the movement of the at least one leaf element between the at least one open position and the closed position.
